(19) United States
(12) Patent Application Publication
(10) Pub. No.: US 2008/0060583 A1
(43) Pub. Date: Mar. 13, 2008

(54) Treat Trainer

(75) Inventor: Peter Leo Liberto, Hartly, DE (US)

Correspondence Address: PETER L. LIBERTO, 759 GUNTER RD., HARTLY, DE, 19953, US

(73) Assignee: Peter Leo Liberto, Hartly, DE (US)

(21) Appl. No.: 11/551,253

(22) Filed: Oct. 20, 2006

Related U.S. Application Data
(60) Provisional application No. 60/758,128, filed on Jan. 11, 2006.

(51) Int. Cl. A01K 5/02

(52) U.S. Cl. 119/54

(57) ABSTRACT

The biscuit dispensing machine is activated by the dog or pet. The machine sits on a base. Affixed to the base is the body of the machine which has and upper compartment that stores the biscuits. Lower part of the body that the pedal mounted into creates the chute. When the pedal is pressed down on by the dog or pet it releases a biscuit down the chute to the to the dog or pet. The pedal is repositioned by a spring or rubber band thus putting the biscuit in the ready position. The machine can be locked in the down position by moving a pin to hold the pedal down, thus deactivating the machine.

### BACKGROUND OF INVENTION

The Treat Trainer is a dog or pet biscuit dispenser that actually allows the pet to access his own treat. By keeping The Treat Trainer loaded with your pet's favorite biscuit, the pet can retrieve a treat when instructed to do so. As the pet learns to depress the pedal of the Treat Trainer when instructed, a treat is released and slides down the chute and lands in front of his nose. This is one of the most effective ways of training a pet is to immediately reward the animal with a treat when the pet has been obedient or exhibits appropriate, acceptable behavior.

### SUMMARY OF THE INVENTION

The Treat Trainer is an easy-to-use product that allows pets to be rewarded for good behavior. The Treat Trainer may be offered in a variety of sizes to suit small, medium, and large dogs, while a version for other pets may also be considered. Manufactured using wood, molded plastic, or similar materials, this durable Trainer can be used repeatedly. This product can be preloaded with approximately 8 to 10 biscuits, and a variety of biscuit brands can be used. The pet must be trained by the user to operate the device, and to take one treat upon instruction or permission. The Treat Trainer consists of a solid base of varying sizes. Affixed to this base is the body of the mechanism, storage compartment, pedal, and biscuit chute. Two hooks will secure a spring or rubber band to both the base and the pedal. When instructed, the pet will press his paw down on the pedal This pedal may then pivot on two strategically located screws. The pedal will then be repositioned, allowing biscuit to leave the chute. The notched pedal will allow a biscuit to slide down onto the pedal when depressed. The tension from the rubber band will prevent biscuits from falling out of the device when the paddle is not depressed.

### BRIEF DESCRIPTION OF DRAWINGS

FIG. 1 Shows the side elevation view of the biscuit dispensing machine.

FIG. 2 Shows an topical angled elevation view of the biscuit dispensing machine.

### DETAILED DESCRIPTION OF DRAWINGS

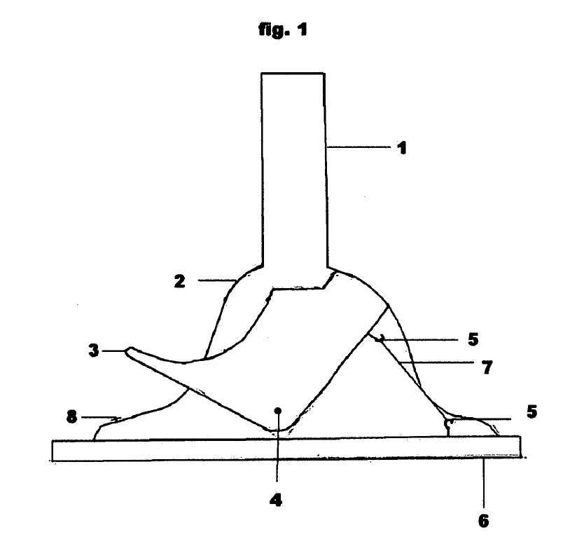

FIG. 1 Shows a base 6 that the side support are affixed to. The side supports consist of a lower 2 and a upper 1 part of which there are 2 side supports to construct this device. When connected together the upper 1 area that the biscuits are loaded into. The pedal attached to the lower 2 side supports by two screws 4 that allow the pedal to pivot. Tension is kept on the pedal 3 by a spring or rubber band 7 that is connected by two hooks 5. One connected to pedal 3 and one to the base 6. A lock 8 is attached to the lower 2 side support on the top side, when turned to the lock position the pedal 3 remains in the down position deactivating the device.

When instructed the dog or pet presses down on the pedal 3 with its paw and releases a biscuit that slides down the pedal 3 and between the two side supports that create chute for the biscuit to slide down and readies for the dog or pet to take.

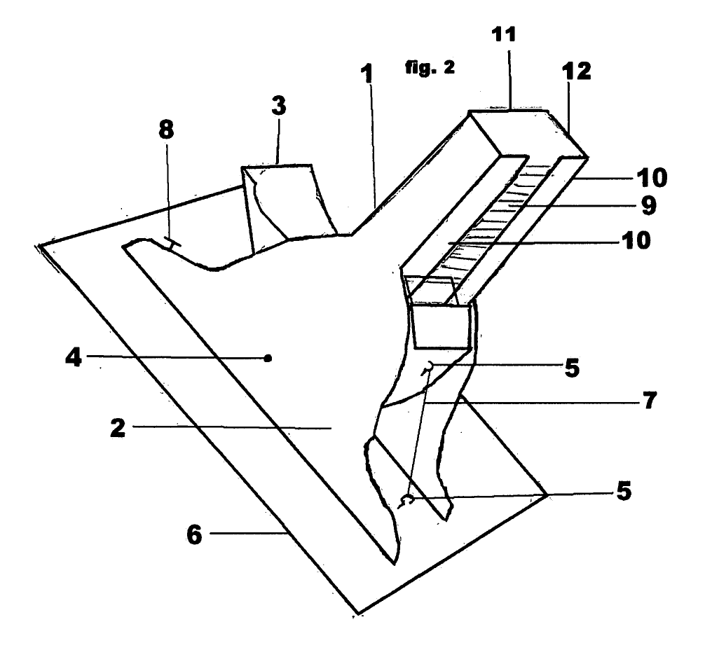

FIG. 2 Shows all embodiments displayed in FIG. 1 and following additional embodiments. Biscuits 9 which are loaded into storage area upper 1 side support. The upper 1 side supports are connected together by a back brace 11 and two front supports 10 that hold biscuits into storage area. Treat Trainer machine 12.

The machine 12 has been described as constructed and arranged especially for operation by a dog or pet. Variations in the size of the machine will occur depending on the size of said biscuit that is used. This will not effect the scope of said Invention.

What is claimed:

1. A biscuit dispensing machine that is activated by a dog or pet pressing down on the pedal with its paw thus releasing a biscuit to the dog or pet as a reward. The said machine comprising:
A. A base that supports the machine;
B. Two side supports connected to the base all constructed from wood and attached to base with glue and nails;
C. A pedal constructed from wood that activates the machine which is attached to the lower side supports by two screws;
D. A back brace that connect the two side supports constructed from wood and attached with glue and nails;
E. Two front supports that hold biscuit in storage place constructed from wood and attached with glue and nails;
F. A locking mechanism to hold pedal down;
G. Two hooks connected to the base and pedal, tension is kept on pedal by a spring or rubber band;

2. The biscuit dispensing machine can be constructed of various materials such wood or plastic but not limited to.
